(19) United States
(12) Patent Application Publication
(10) Pub. No.: US 2024/0362649 A1
(43) Pub. Date: Oct. 31, 2024

(54) CUSTOMER NOTIFICATION SYSTEM BASED ON OUTAGE STATE OF RISK PREDICTION

(71) Applicant: The Texas A&M University System, College Station, TX (US)

(72) Inventors: Rashid Baembitov, College Station, TX (US); Mladen Kezunovic, College Station, TX (US)

(73) Assignee: The Texas A&M University System, College Station, TX (US)

(21) Appl. No.: 18/645,578

(22) Filed: Apr. 25, 2024

Related U.S. Application Data
(60) Provisional application No. 63/461,708, filed on Apr. 25, 2023.
(60) Provisional application No. 63/461,705, filed on Apr. 25, 2023.

(51) Int. Cl. G06Q 30/01; G06Q 10/04

(52) U.S. Cl. CPC G06Q 30/01; G06Q 10/04

(57) ABSTRACT

A system for customer notification system based on outage state of risk prediction, comprising a correlator system operating on a processor and configured to receive uncorrelated outage data, weather data and graph data and to generate geographically and temporally correlated outage data, weather data and graph data. A machine learning system operating on a processor and configured to receive geographically and temporally correlated outage data, weather data and graph data and forecast data and to generate prediction data. A state of risk system operating on a processor and configured to receive the prediction data and to generate state of risk data. A customer notification system operating on a processor and configured to receive the state of risk data and to generate customer notifications as a function of the state of risk.

### RELATED APPLICATIONS

The present application claims benefit of and priority to U.S. Provisional Patent Application No. 63/461,708, filed Apr. 25, 2023, and U.S. Provisional Patent Application No. 63/461,705, filed Apr. 25, 2023, each of which are hereby incorporated by reference for all purposes as if set forth herein in its entirety.

### TECHNICAL FIELD

The present disclosure relates generally to customer notification systems and methods of operation, and more specifically to a customer notification system based on outage state of risk prediction.

### BACKGROUND OF THE INVENTION

Utilities can generate customer notifications of potential outages, which can help customer undertake measures to mitigate outage impacts.

### SUMMARY OF THE INVENTION

A system for customer notification based on outage state of risk (SoR) prediction is disclosed, and includes a correlator system configured to receive uncorrelated outage data, weather data and graph data and to generate geographically and temporally (spatiotemporally) correlated outage data, weather data and graph data. A machine learning system is configured to receive geographically and temporally correlated outage data, weather data and graph data and forecast data and to generate prediction data. An SoR system is configured to receive the prediction data and to generate SoR data. A customer notification system is configured to receive the SoR data and to generate customer notifications as a function of the SoR.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a system for customer notification as a function of outage SoR prediction, in accordance with an example embodiment of the present disclosure; and

FIG. 2 is a diagram of an algorithm for customer notification as a function of outage SoR prediction, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

The present application claims benefit of and priority to U.S. Provisional Patent Application No. 63/461,708, filed Apr. 24, 2023, which is hereby incorporated by reference for all purposes as if set forth herein in its entirety.

The present disclosure provides a novel approach to assess the outage SoR as a function of weather and vegetation in the distribution grid. A Machine Learning (ML) prediction algorithm is used in conjunction with a Geographic Information System (GIS) application for mapping the SoR for an entire utility network. The disclosed systems and methods for optimization provide numerous mitigation strategies that utility staff and customers can use to minimize the impact of outages. The disclosed SoR assessment also enables the implementation of an innovative decision-making solution for utility operators, represented in the form of risk maps. Additionally, utilizing the SOR assessments, a Customer Notification System (CNS) is used to enhance customer awareness and facilitate the adoption of mitigation measures. This holistic approach shifts outage management from a reactive process to a proactive initiative, promoting grid resilience and reliability through planned outage mitigation.

Outages in an electric system impose significant losses to the economy as well as a major non-monetary detrimental societal impact. It has been reported that the population of the United States experiences more blackouts than in any other developed nation. Based on the Electric Emergency Incident and Disturbance Reports (Form DOE-417) from the US Department of Energy (DoE), the annually affected load loss has increased more than 10-fold from 3247.6 MW/year to 39411 MW/year, and the number of affected customers has increased from 6,524,651 customers/year to 8,603,823 customers/year. DoE gives an estimate of $150 to $164 billion per year as the annual cost of outages to the US economy.

The research in outage loss estimation shows that a notification of the customers about the upcoming possible outage can reduce the outage costs by 25-70%. Providing notification to customers about a possible outage transforms the experience from an unexpected, forced event into a planned event with some assigned probability. Incorporation of the disclosed CNS into the operations of a utility company provides a way to limit the losses from outages by allowing utility staff and customers to coordinate mitigation strategies ahead of time to reduce the outage impact. Additionally, if the operators receive a timely estimation of the current SoR of the system, they can engage in better decision-making, leading to improved resilience and power quality. Thus, timely and precise prediction of the SoR of outages is of utmost importance for limiting economic and societal losses and ensuring public safety.

ML and developments in remote sensing and weather forecasts can be combined using the present disclosure with GIS to implement the disclosed SoR prediction embodiments. Incorporating data from diverse sources and combining it with historical data about the causes and location of outages from a utility company allows the creation of datasets for SoR ML algorithm training and testing. The resulting SoR prediction, if integrated into utility daily operations, allows planning of a variety of mitigation actions, such as equipment replacement and repair, customer notification, network topology switching and back-up generator startup, which can reduce the overall impact and curtail losses.

ML ensemble models can be used to predict outages in distribution networks resulting from catastrophic weather events. For example, analysis of network resilience can be performed by employing predicted risk levels produced by the Naïve Bayes model. An approach to distribution transformers (DT) outage prediction using Logistic Regression is also known. Optimization of tree trimming scheduling based on predicted SoR can also be utilized. While these systems use short and long-time horizon weather forecasts as input to the prediction model, the associated uncertainty level in long-term weather forecasts increases with time and adversely affects the accuracy of predicted SoR.

The present disclosure identifies the key data sources for outage SoR predictions, provides a new spatiotemporal approach for GIS data processing for predicting outage SoR using ML on historical data, and formulates a novel mitigation optimization method that uses SoR predictions to determine the best mitigation strategy for reducing the outage impacts on a utility and enhancing customer satisfaction levels. In one example embodiment, day-to-day operations are scheduled during severe weather that doesn't cause catastrophic damage to infrastructure. With the introduction of SoR prediction, outage management is transferred from reactive to proactive, allowing utility staff and customers to anticipate and prepare for a possible outage.

An SOR prediction can include a spatiotemporal dimension. The GIS ArcGIS Pro software, available from Esri of Redlands, CA or other suitable systems can be used to analyze the spatial dimension, such as by utilizing graphic user interface (GUI) tools. Other resources that can be used include the Python library available from python.org and the arcpy library available from Esri of Redlands, CA. These and other resources can be used if a) the history and order of data manipulation and the utilized tools are automatically preserved and logged and can be readily changed, updated and re-run on the same types of datasets, b) the computer code (as opposed to manual processing) has inherent scalability, so it is applicable for processing significant amounts of data in parallel, and c) the code is structured, to reduce human error when developing and documenting it.

It is important to organize geodatabase (GDB) used with a spatial dimension analysis tool such as ArcGIS, by defining feature datasets (FD) within geodatabases to logically place initial data and intermediate results.

The location of distribution feeders can be encoded in utility-provided shape files and imported into a GDB. A merge operation can be used to combine them into one feature class (FC). One advantage of organizing data into an FD is that it ensures that the same coordinate system is used for all FCs within the FD. All distribution feeders can be placed into a single FD.

The locations of the outages can be imported into a GDB based on the latitude and the longitude from the utility-provided data. The initial outage locations might not intersect the feeders in some parts of the system for several reasons, such as insufficient accuracy during data acquisition. To address this condition, a snap tool such as one from ArcGIS or other suitable tool can be used to associate all the outages with a corresponding feeder segment. A snap tool typically moves each outage point to the closest feeder.

A service area of interest can be located near a major city and spread across one or more counties. Shape files with county boundaries can be imported into a GDB as a separate FD. After importing, they can be merged to transform the data by generating an FC representing all the counties. County FCs can be used to clip bigger datasets or to cluster the processing of bigger datasets (for example, imagery datasets).

To obtain weather data, weather stations that are located closest to the network can be used. The number of weather stations (WS) in the area can change throughout the years, and it is possible that data may be added in a new location near the area of interest, lost from a source that goes out of commission, or that some of the data may become available after being unavailable for certain periods. One approach to address this contingency is to use the WSs that have complete data sets for the entire period of interest and to discard the rest, but other suitable approaches can also or alternatively be used. Each row of data in the weather dataset can have a timestamp, the name of WS where the measurement was taken, WS coordinates and other suitable data. The coordinates of each WS can be extracted into separate files and then imported into GDB as points, or other suitable processes can also or alternatively be used.

A prediction object or prediction entity needs to be defined. Multiple distribution feeder segments can be grouped into clusters with the same circuit name identifier (CKTID) as a prediction entity. Risk levels can then be estimated and predicted for each CKTID in the system. This framework can be used on a single feeder segment, an area served by a single substation, an entire distribution system or other suitable prediction entities.

One of the ways to spatially aggregate information about an object is the use of buffers, which are polygons created around geographical objects with a predefined distance from the object. A buffer allows the extraction of the necessary information that belongs to a particular object from various datasets. Different buffers can be used around different objects, such as different distribution feeders, such as 20, 100 and 500-meter buffers or other suitable buffers. Buffers can be grouped by county or other suitable geographic shapes, such as to process imagery datasets in several steps to decrease processing time, reduce CPU requirements, lower possible errors. In this regard, the CPU requirements associated with machine learning analysis can significantly impact the ability to analyze large data sets, so the novel use of buffers to define data sets that are suitable for machine learning is an important technical feature of the present disclosure. Processing imagery in a single step is very computationally intense, unstable, and prone to software errors.

In GIS data provided by the utility, feeder segments might not have an assigned CKTID, and those feeders can be represented as NULL feeder segments. This issue can occur when recently built feeder segments are imported into the database but are not assigned CKTIDs. The following procedure can be used to assign missing CKTIDs and to ensure feeder connectivity. First, CKTIDs can be assigned to the NULL feeder segments based on their geographical proximity and connection their to feeders, particularly at the points where they touch. Using a spatial self-join with parameter “boundary touches” can yield inadequate results.

Next, an iterative process is used to dissolve or fuse together feeder segments that meet into bigger clusters. First, the NULL segments touching known feeders are joined. Next, NULL segments that do not touch any known feeders can be combined into NULL clusters based on their connectivity to each other. These NULL clusters can be assigned CKTIDs based on proximity to known feeders. In this manner, the feeder segments can form clusters, growing from single elements to fully connected parts. The segments with the CKTIDs known can be separated in the beginning and later used as a reference for assigning CKTIDs to NULL clusters. After all the segments have a CKTID assigned, the datasets can be merged (combined) into a single dataset.

In some cases, identical NULL clusters can be formed if each NULL cluster has several initial starting points. In the absence of prior information on where and which segments can form a NULL cluster, any NULL segment can be a starting point for a NULL cluster. To overcome this problem, identical clusters can be removed at the end of the process. The proposed method can be enhanced by initializing a cluster center to reduce the number of iterations and computational burden. Five iterations may be sufficient to cluster all the NULL segments, depending on the size of the data set that is being analyzed.

Deficient GIS data can adversely impact the quality of the SoR predictions. Small variations in the GIS placement of feeders, if they remain in proximity to their actual locations, might not have a drastic impact on the framework's performance. One exception is mountainous regions where environmental conditions can vary significantly between peaks and valleys. In such territories, a higher degree of precision in mapping the power lines' locations is preferable. Another issue is mislabeling of GIS objects, which can lead to using incorrect geographical information by ML algorithms and result in the learning of inaccurate patterns, ultimately producing less reliable predictions. In the present disclosure, the use of NULL segments yields adequate results as long as the number of NULL segments is low and they are in the vicinity of known feeders.

While the opportunity to incorporate datasets using the present disclosure is broad, one limitation is the time required for steps associated with incorporation, such as searching and identifying new data sources, learning how to deal with new datasets, creating an automated process for data incorporation, providing computational resources for data processing, and retraining and recalibrating the data model. To address such issues, a diverse dataset can be used, such as a dataset from the National Oceanic and Atmospheric Administration (NOOA) Big Data Initiative Program, which offers public access to open data by accreting its uniquely generated data (satellites, radars, ships, weather models) to public and private partnerships through commercial cloud platforms. Datasets from different compatible data sources can also or alternatively be combined, including but not limited to utility provided data, National Agriculture Imagery Program (NAIP) imagery, Automated Surface Observing Systems historical weather from NOAA, historical lightning data available from Vaisala of Vantaa, Finland, county borders disposition data available from Esri of Redland, CA or other suitable datasets.

An iterative approach for adding new datasets (or altering any step in the framework) can be developed using continuous integration and continuous delivery, which offers several benefits in SoR prediction applications. One benefit is process standardization and streamlining. New features can also be constantly added to the framework, and new dataset effects can be readily evaluated against previous implementations. Testing and quality control procedures can also be used to ensure a smooth transition to the production stage.

Different data parameters on the outage SoR predictions can have an impact. Utility-provided historical outage logs contain information about outages. Separating planned outages from all other types of outages can identify how faults are distributed throughout time. Outages can be aggregated by the quarter of occurrence and cause. Environmental conditions (vegetation or weather) can constitute a substantial portion of known causes of outages.

Historical weather data can be obtained from the National Oceanic and Atmospheric Administration (NOAA) Automated Surface Observing System (ASOS). A historical weather dataset can be obtained in a predetermined temporal resolution, such as from 5 min to 1 hour. Data can also be obtained from the Iowa Environmental Mesonet (IEM), such as by using a script for the automated download of data, and can include selected weather station locations, types of weather parameters, timespan and other suitable parameters.

Weather parameters that can be used include air temperature, dew point temperature, wind direction (such as in degrees from true north or other suitable units), wind speed, wind gust, one-hour precipitation for the period from the observation time to the time of the previous hourly precipitation reset, relative humidity, present weather codes and so forth. The missing data can be detected and discarded for each WS and parameter.

The duration of high wind speed can be accounted for by summing a predetermined number of hours (such as 3, 6 and 12 hours) having wind speed higher than predetermined values (such as 7, 10 and 13 knots). The number of hours and wind speeds can be modified to focus on normal weather, severe weather where the infrastructure remains intact, catastrophic weather with very high winds or other suitable types of weather. The weather parameters can be spatially correlated to CKTIDs, such as by using a centroid of a CKTID as a point where the weather parameters need to be calculated or in other suitable manners. The distances between each centroid of CKTID and WS can be calculated and stored in a table and can be used to calculate weather parameters for each CKTID.

To spatiotemporally correlate weather parameters to the outages, an average of the available parameters for each event weighted by distance and time can be obtained using equation (1):

$${P}_{CKTID} = \frac{{\sum }_{i = 1}^{N} {Wgeog}_{i} \cdot {Wtime}_{i} \cdot {P}_{i}}{{\sum }_{i = 1}^{N} {Wgeog}_{i} \cdot {Wtime}_{i}} , \\ where {Wgeog}_{i} = \frac{1}{Geographic dist . ( CKTID ; WS )} , {Wtime}_{i} = \frac{1}{Time dist . ( Weather measurement time ; Event time )} . \qquad ( 1 )$$

In the present disclosure, the Euclidean distance between the centroids of CKTIDs and the WSs is a geographical distance, but other suitable distances can also or alternatively be used. A time distance kernel defined by equation (2) can be used for the time distance:

$$Time dist . ( t 1 ; t 2 ) \{ \begin{matrix}1 , if t 2 - t 1 < 60 min \\ ∞ , otherwise\end{matrix} \qquad ( 2 )$$

The time distance kernel of equation (2) incorporates measurements available in a 1-hour window before the event and discards measurements outside this window, which assumes that the weather preceding a fault has a major effect on it. Different time kernels can be used to give more weight to measurements that are closer to the event timestamp, or other suitable time kernels can also or alternatively be used.

For each hour of this example embodiment, the weather parameters are calculated for corresponding CKTIDs using distances between CKTIDs and WSs. Afterwards, the dataset can be labeled into two classes: faults and normal operation (NO) based on the timestamps of fault occurrence. To address the imbalance of the dataset, NO is randomly sampled to be of the same order as faults. Vegetation and weather caused outages are considered.

National Agriculture Imagery Program (NAIP) imagery data can be used from Texas Natural Resources Information System (TNRIS). NAIP imagery can include red, green and blue color band data or other suitable data, and where each band can be captured by a separate sensor during the imagery acquisition (such as from aerial photography) or in other suitable manners. NAIP imagery can be clustered by county and updated every two years or collected in other suitable manners.

Specific parts of the imagery data can be extracted that are near the feeders having features that characterize an amount of vegetation around the feeders and how close vegetation is to a feeder. When there is more vegetation around a feeder and a smaller the proximity to the feeder, there can be a bigger the risk of an outage, such as due to an increased probability of tree branches touching conductors during strong wind, trees and/or branches falling onto the feeder during severe weather conditions, and trees growing into the conductors from underneath the feeder or other conditions.

In one example embodiment, 12 NAIP imagery datasets consisting of 4 datasets corresponding to the counties for each of 2010, 2012, and 2014 were used, and the computer used for the processing was implemented using 16 cores of Intel® Core™ 19-9900 CPU with 3.1 GHZ and 64 GB of RAM. One NAIP raster consumed around 30% of the computer resources during clipping, allowing 3 parallel computing nodes to be run simultaneously on one machine. Buffers of 20 meters around lines grouped by county were used as the clipping boundaries for imagery.

After the clipping was finished, raster files in 20 meters vicinity around feeders in each county were generated. Tree locations were separated from the rest of the dataset using unsupervised clustering followed by the reclassification of raster cells into either a vegetation or no vegetation category. In this example embodiment, the ArcGIS Pro IsoCluster unsupervised clustering tool was used by specifying an empirically identified number of clusters. The optimal number was determined to be around three times the number of bands in a raster dataset, or 30 clusters.

After running unsupervised clustering, a raster with cells classified into 30 clusters was obtained. Information embedded in all the bands was used to assign the cluster to each cell. Each cluster can then be identified as corresponding to an area with or without vegetation. The resulting reclassified raster can represent the location of vegetation around the power lines. Once all the raster files for counties are reclassified, same-year files can be merged, and the reclassified raster files can be converted into vector representation for easier use with other datasets.

Lightning data can be obtained from the National Lightning Detection Network operated by Vaisala or other suitable sources. Information can be collected for each lightning strike, such as the location of the lightning strike, a timestamp, a lightning current, a type of lightning (cloud to cloud or cloud to ground) or other suitable data. Lighting data can be imported into the GDB as points, and the cloud-to-ground lightning strikes can be extracted and sundered into different FC for each year, based on the assumption that only the cloud-to-ground lightning strikes affect the feeders and cause outages. The absolute value of the current can be calculated from the original current to account for polarity.

Certain parts of the network may be more susceptible to lightning strikes than others, which results in a higher risk for such parts of the network. The reason might be in its geographical location and its surroundings: if the feeder pole as a relatively tall structure is standing out in a particular area, then the lightning is more likely to strike it since lightning is statistically more likely to strike taller objects on the ground. Buffers can be used to compile statistics of lightning strikes over different CKTIDs. Multiple distances can be used, such as 5, 10, 15, 20, 30, 50, 100, 500, and 1000 meters, and a predetermined number of buffers can be used around each CKTID of the network. The number of lightning strike hits inside each buffer can be counted over a predefined time interval and their average current can be calculated for use as features for the ML classifier.

In one example embodiment, the performance of a Random Forest (RF), Logistic Regression (LR), and Catboost (CB) classifier were compared. Performance was measured by the following metrics: F1 Score, Area Under the Precision-Recall Curve (PRC AUC), and Area Under the Receiver Operating Characteristic (ROC AUC). The classifiers were trained and tested using Stratified K-Folds cross-validator with 5 folds. The average performance metrics scores of the algorithms are presented in Table I. The highest achievable score for each metric was 1.0. This data indicates that while ML algorithms show strong predictive abilities, they are not flawless. Specifically, both CB and RF demonstrate similar performance, surpassing LR. A direct and unbiased performance comparison with existing methods is challenging, given the variations in spatiotemporal focus among studies and the unique regional weather patterns they consider.

TABLE I
PERFORMANCE METRICS SCORES

| | RF | LR | CB |
|---|---|---|---|
| ROC AUC | 0.91 | 0.761 | 0.926 |
| PRC AUC | 0.916 | 0.748 | 0.93 |
| F1 | 0.823 | 0.655 | 0.836 |
| Precision | 0.857 | 0.662 | 0.872 |
| Recall | 0.793 | 0.65 | 0.803 |

The ML classifier outputs the probability of an outage under given weather conditions for each individual CKTID in the network for a given timestamp. The SOR values for several timestamps can be combined and exported as a .csv table and then imported into ArcGIS. The tables can have the prediction timestamp as a separate column to use the time-series visualization capabilities of ArcGIS. After importing, the risk values from the algorithm can be joined with lines FC. Predefined layer symbology parameters can be applied to the imported dataset to standardize a color scheme or other suitable identifiers.

Depending on the input data, the spatial differentiation of a risk map may not be as accurate as differentiation timewise. The risk maps can be used by utilities to improve real-time awareness of network vulnerabilities and support predictive decision-making practices. Risk maps can be provided to and used by utility personnel to establish various proactive measures that will help mitigate future high risks in the system. The risk map information can also be provided to and used by customers to prepare for times of elevated SoR levels.

The present disclosure provides an application of SoRs to deploy a CNS by a utility, which improves the overall satisfaction of the customers. Mitigation optimization based on SoR predictions is also disclosed. The present disclosure differs from the current reactive approach, where the assessment of an impact of an event is performed after an event (postmortem). The proactive approach utilized and implemented by the present disclosure notifies customers in advance and allows them to prepare for a possible power interruption.

The present disclosure recognizes that given the SoR for the future timesteps for different parts of the network, it becomes feasible to devise and select appropriate mitigation measures that reduce or eliminate the losses resulting from outages. An optimization approach is disclosed that is based on acquired SoR levels, which outputs a set of mitigation actions from a predefined set for a given situation.

The objective function [symbol] (X) of optimization is maximized by selecting the mitigation actions (MAs) from the set Θ. The choice of a specific [symbol] (X) is made to best suit the interests and priorities of utility companies and end consumers. The objective function can optimize the overall outcome and ensure that the selected MAs effectively address the needs and concerns of the stakeholders involved.

The set of mitigation actions Θ (by utility and/or customers) can be determined by the availability of the resources, system topology, cost of action, market conditions, level of flexibility of consumers, time of the day, societal expectations, and so forth. Certain utility actions can necessitate longer time frames and require more resources, such as replacing old equipment or executing tree trimming. Some customer actions can be taken immediately, such as canceling a family event or moving to a warming/cooling center. These attributes comprise the inertia of an agent towards a specific mitigation action, reflecting their inclination and readiness to undertake it.

The constraints gᵢ(X) and hⱼ(X) that may be present in the system at the time of MA scheduling and execution should also be accounted for. Some MA can be infeasible at the time of high risk, while other parameters may need to remain unchanged. Accounting for these constraints ensures that the selected MAs align with the current system conditions and limitations.

The proposed approach for optimization can be summarized as follows from equations (3) and (4):

$$arg {max}_{Θ} ℱ ( X ) \qquad ( 3 )$$

$$s . t . : \{ \begin{matrix}{g}_{i} ( X ) \leq 0 , i = 1 , … , l \\ {h}_{j} ( X ) = 0 , j = 1 , … , k\end{matrix} \qquad ( 4 )$$

where X represents a vector of parameters on which the objective function and constraints depend.

A customer satisfaction index (CSI) can be used to quantify customers satisfaction with utility services. The CSI can be improved by sending notifications to customers about potential outages in the system that can affect them.

Each customer can be assigned a utility function (UF) denoted by rⱼ(t1,t2), see equation (5). This function represents the customer's perceived value of being correctly or falsely notified about an outage that will eventually happen in a predefined time interval, in terms of the cost of false positive (FP) and false negative (FN) signals and the reward of true positive (TP) and true negative (TN) signals provided by the prediction model. The UF reflects Customer Interruption Cost since it aggregates both direct and indirect impacts. The utility function can be dependent on time because it may change throughout the day/month/year and is subject to personal preference:

$${r}_{j} ( t 1 , t 2 ) = \{ \begin{matrix}{a}_{j} - \int {φ}_{j} ( Tout ) dTout , if {O}_{j} ( t 1 , t 2 ) = + 1 , {N}_{j} ( t 1 , t 2 ) = + 1 \\ {b}_{j} - \int {γ}_{j} ( Tout ) dTout , if {O}_{j} ( t 1 , t 2 ) = + 1 , {N}_{j} ( t 1 , t 2 ) = - 1 \\ {c}_{j} , if {O}_{j} ( t 1 , t 2 ) = - 1 , {N}_{j} ( t 1 , t 2 ) = + 1 \\ {d}_{j} , if {O}_{j} ( t 1 , t 2 ) = - 1 , {N}_{j} ( t 1 , t 2 ) = - 1\end{matrix} \qquad ( 5 )$$

where
a is a reward for a correct notification about an outage that has occurred,
b is a penalty for a missed notification about an outage that has occurred,
c is a penalty for an incorrect notification about an outage that did not happen (disturbance cost),
d is a reward for not notifying when there is no outage,
φⱼ and γⱼ are dissatisfaction rate functions,
Tout is the duration of an outage.

Indicator functions Oⱼ(t1,t2) and Nⱼ(t1,t2) can also be used that take a value of +1 in case of an outage or notification taking place, respectively, and a value of −1 in case of an outage or notification not taking place in the time interval [t1,t2, see equations) (6) and (7):

$${O}_{j} ( t 1 , t 2 ) = \{ \begin{matrix}+ 1 , if outage occurred during [ t 1 , t 2 ) \\ - 1 , otherwise\end{matrix} \qquad ( 6 )$$

$${N}_{j} ( t 1 , t 2 ) = \{ \begin{matrix}+ 1 , if notification sent during [ t 1 , t 2 ) \\ - 1 , otherwise\end{matrix} \qquad ( 7 )$$

During an outage (Oⱼ(t1,t2)=+1), the UF includes an integral of the dissatisfaction rate functions φⱼ and γⱼ with respect to Tout. The longer it takes to reconnect the power supply to a customer once the outage happens, the more dissatisfied the customer typically becomes with the utility. The dissatisfaction rate from the outage duration is different in case of being notified in advance and not being notified in advance. The form of functions is not limited to exponential functions and can be an arbitrary function, perhaps determined through behavioral experiments.

The contents of a notification message to a customer can consist of a set of items: outage probability, expected outage duration, possible mitigation actions, recommendations and so forth. An effective message structure can yield better satisfaction and a more considerable impact reduction. Formulation of the message structure and estimation of how efficiently a customer acts, given the notification, can also be addressed. The message can also be as simple as a warning about a potential outage in the customer's area in the next hour, and each customer can be assumed to act according to his/her personal circumstances to reduce outage impact. A response from specific customers can also be received, such as by including a response control in a notification message and by generating one or more data queries to allow the customer to provide target information.

Tres_{cust} is the expected time of restoration of power the customer anticipates, and when the power outage lasts more than Tres_{cust}, dissatisfaction grows at an accelerated rate. The Tres_{cust} is customer dependent and, in general, is affected by the personal background and experience of a particular customer. For example, a customer may base his/her estimation based on previous outages. The time of restoration expected by a customer can be purposely influenced by a utility sending a notification of the expected restoration time for a particular outage, thus, making the customer's expectation more specific.

A utility has its own expected restoration time for each outage: Tresᵤₜᵢₗ. It can be predicted by a separate ML model, can be assessed by means of statistical analysis for various parts of the system, for example, using the historical mean, or determined in other suitable manners. A repair crews' allocation during outages can be optimized by reducing actual restoration time for customers with higher dissatisfaction rates. In this manner, repair crew work orders, travel routing, and other parameters can be adjusted as a function of customer feedback, such as to ensure that repair crews have the proper equipment for a repair. The repair crews can be selected as a function of equipment, equipment can be checked out to a repair crew based on the type of repair, or other suitable processes can also or alternatively be used.

The actual restoration time is denoted as Tres_{actual}. The dissatisfaction of a customer would be calculated by comparing the actual and predicted restoration time for each outage. The decision on MA can be made based on the expected values since the actual restoration time is not available at the time of making the decision.

The coefficients of the utility function and dissatisfaction rate functions for individual customers can be subject to behavioral economics assessment because the perceived cost/value of an outage by a customer is different from the monetary cost/value. Specific responses, surveys of customer opinions or other suitable processes can be used to determine the customer data, and the utility functions can be provided by the utility.

By informing customers about potential disruptions, their overall satisfaction can be improved, and inconvenience caused by unexpected service interruptions can be reduced. The notifications serve as a proactive measure to keep customers informed and engaged, enhancing their perception of the utility service provider's responsiveness and reliability.

Satisfaction Index CSIⱼ for a given customer j is a sum of all rewards/penalties increments from the UF up to a given moment in time t0, discounted by a discounting factor E (8):

$${CSI}_{j} ( t 0 ) = {\sum }_{t = - ∞}^{t 0 - dt} [ {r}_{j} ( t , t + dt ) \cdot {O}_{j} ( t , t + dt ) \cdot {N}_{j} ( t , t + dt ) ] {e}^{t \cdot E} , \qquad ( 8 )$$

where dt is a discretization time step.

The likelihood of an outage is reflected by the SoR, which represents the conditional probability p of the system element i failure in the time interval [t1,t2) given the set of operation conditions Ω, which includes historical and forecast weather conditions, system topology, loading and generation conditions, and so forth, using equation (9):

$${SoR}_{i} ( t 1 , t 2 \vert Ω ) = p ( element i fails in [ t 1 , t 2 ) \vert Ω ) \qquad ( 9 )$$

Each customer j in the network at current time t0 can be described by the following parameters or other suitable parameters, including SoR:
Geographical location of the customer in the network,
Customer location in the grid topology (electrical location),
SoRs for the next time intervals: SoRⱼ(t0,t1), SoRⱼ(t1,t2) . . . ,
History of experienced outages in the past: HOⱼ(t0)
History of the notifications sent: HNⱼ(t0),
UFs for the next time intervals: rⱼ(t0,t1), rⱼ(t1,t2) . . . ,
Current Customer Satisfaction Index: CSIⱼ(t0).
   The relation between element i and customer j can be formulated in several ways. In this example embodiment, element i can be feeder to which customer j is connected.

Given the uncertainty of the outage in the future period, a random variable can be defined that represents the possible gain or loss of the CSI ΔCSIⱼ using the predicted SoR levels for that period. The gain/loss of the next period can depend on whether the notification will be issued and whether an outage will take place. The probability mass function (PMF) of such random variable is presented in (10) (time periods are omitted to simplify the notation):

$$P ( Δ {CSI}_{j} = {a}_{j} + \int {φ}_{j} ( Tout ) dT out \vert O = 1 , N = 1 ) = SoR P ( Δ {CSI}_{j} = - {b}_{j} - \int {γ}_{j} ( Tout ) dTo ut \vert O = 1 , N = 1 ) = SoR P ( Δ {CSI}_{j} = - {c}_{j} \vert O = - 1 , N = 1 ) = 1 - SoR P ( Δ {CSI}_{j} = {d}_{j} \vert O = - 1 , N = - 1 ) = 1 - SoR \qquad ( 10 )$$

The action vector θⱼ represents a mitigation action for each customer (11):

$${θ}_{j} = \{ \begin{matrix}( 1 & 0 ) , if N = + 1 \\ ( 0 & 1 ) , if N = - 1\end{matrix} \qquad ( 11 )$$

The objective function [symbol] (X) at time t0 for the optimization is to maximize the Customer Satisfaction Index in the next period across the entire grid with consideration of Satisfaction Index change ΔCSIⱼ, which is an expected value of future reward/penalty of the utility function, given the SoR (12):

$$ℱ ( X ) = {\sum }_{j = 1}^{M} {CSI}_{j} ( t 0 ) + {θ}_{j} \cdot ( \begin{matrix}E ( Δ {CSI}_{j} \vert N = 1 ) \\ E ( Δ {CSI}_{j} \vert N = - 1 )\end{matrix} ) , \qquad ( 12 )$$

where M is the total number of customers in the grid.

Using SoR, we can calculate the expected values of the Satisfaction Index change for both cases: notification will be sent (N=1) and will not be sent (N=−1) (13):

E(ΔCSIⱼ|N=1)=

$$SoR \cdot ( {a}_{j} - \int {φ}_{j} ( Tout ) dTout ) + ( 1 - SoR ) \cdot ( - {c}_{j} ) E ( Δ {CSI}_{j} \vert N = - 1 ) = SoR \cdot ( - {b}_{j} - \int {γ}_{j} ( Tout ) dTout ) + ( 1 - SoR ) \cdot ( {d}_{j} ) \qquad ( 13 )$$

The optimization problem is then to choose such mitigation vectors θⱼ, so that the objective function is maximized or, in other words, to choose which customers should be notified about possible outages.

There are several constraints to the optimization problem. First, a customer is not notified if there is already an outage at its feeder. Second, each customer can have a “do not disturb” mode when notifications are not accepted. A third constraint can be the total number of notifications in the system. Even though the cost of sending a single notification is small (given that the notifications are sent by means of the Internet), in an exceptionally large system sending frequent notifications may require more processing power in the hardware and faster Internet connections. The constraints are summarized in (14):
θⱼ=(0 1), if experiencing an outage
θⱼ=(0 1), if “do not disturb” mode

$${\sum }_{j = 1}^{M} {θ}_{{j}_{1}} - {N}_{max} \leq 0 , \qquad ( 14 )$$

where Nₘₐₓ is the maximum number of notifications in each period.

To further r improve the CSI of the customers, an additional step in optimization can be used: find and set minimum SoR threshold SoRₘᵢₙ(s,t) as a function of time t and locations s, below which the notifications will not be issued (15):

$${θ}_{j} ( s , t ) = ( \begin{matrix}0 & 1\end{matrix} ) , if {SoR}_{j} < {SoR}_{min} ( s , t ) \qquad ( 15 )$$

This hyperparameter can be used to fine-tune message notifications and tie thresholds to a current situation in the service area. The minimum threshold can be updated on a periodic basis (which can be chosen arbitrarily) based on the performance of the CNS in the last period(s). The value of the SoRₘᵢₙ(s,t) is the threshold to maximize the SI at location s during the previous period(s).

The impact of CNS implementation on 1 year of real-life data has been studied. A utility function for each customer in the network was randomly generated. The forms of dissatisfaction rate functions were assumed to be linear (16):

$${φ}_{j} ( Tout ) = \{ \begin{matrix}λ {1}_{j} Tout , if Tout < Tres \\ λ {2}_{j} Tout + {w}_{j} , otherwise\end{matrix} {γ}_{j} ( Tout ) = \{ \begin{matrix}μ {1}_{j} Tout , if Tout < Tres \\ μ {2}_{j} Tout + {z}_{j} , otherwise\end{matrix} \qquad ( 16 )$$

where 0<λ1<λ2, 0<μ1<μ2, λ1<μ1, λ2<μ2, and wⱼ and zⱼ are such that the functions are continuous in Tres_{cust}.

The studied system was assumed to have a total of 698,313 customers located at different feeders. The time of restoration Tres_{actual} of an outage obtained from utility provided data. Tresᵤₜᵢₗ was set to 2 hours for all outages, based on current utility practices. For each customer, Tres_{cust} was modeled as a sample from a lognormal distribution with a mean of 0.7 hours and a standard deviation of 0.2 hours. Coefficients λ1, λ2, μ1, μ2 were modeled by uniform distribution with bounds (0,1) respecting the conditions above. The utility function coefficients have only 2 degrees of freedom, resulting in models of dj=0, bj=0.1, aj as a lognormal distribution with a mean of 1 and standard deviation of 1, cj as a lognormal distribution with a mean of 1 and standard deviation of 1, multiplied by 0.01.

In general, the coefficients aj, bj, cj, dj can be of any suitable sign, but for the study all the coefficients were modeled as a positive number. The initial CSIⱼ for each customer is assumed to be zero.

To ensure the robustness of the results, the test was repeated for the entire system on 1 year of data for a total of 150 times, which was enough samples for the Central Limit Theorem to be applicable, and the results of each run were recorded. The result of the optimization runs established that the usage of CNS based on SoR predictions improved the CSI by 54.3% on average.

Employing an iterative approach for incorporating new relevant datasets can improve the performance evaluation of the SoR prediction models. One practical value of SOR maps for utilities is in their ability to assist with planning for and anticipating potential outages, enhancing their operational preparedness for inclement weather events. Proactive outage management facilitated by CNS allows utilities to effectively communicate with customers, raising overall satisfaction levels and minimizing detrimental outage impacts.

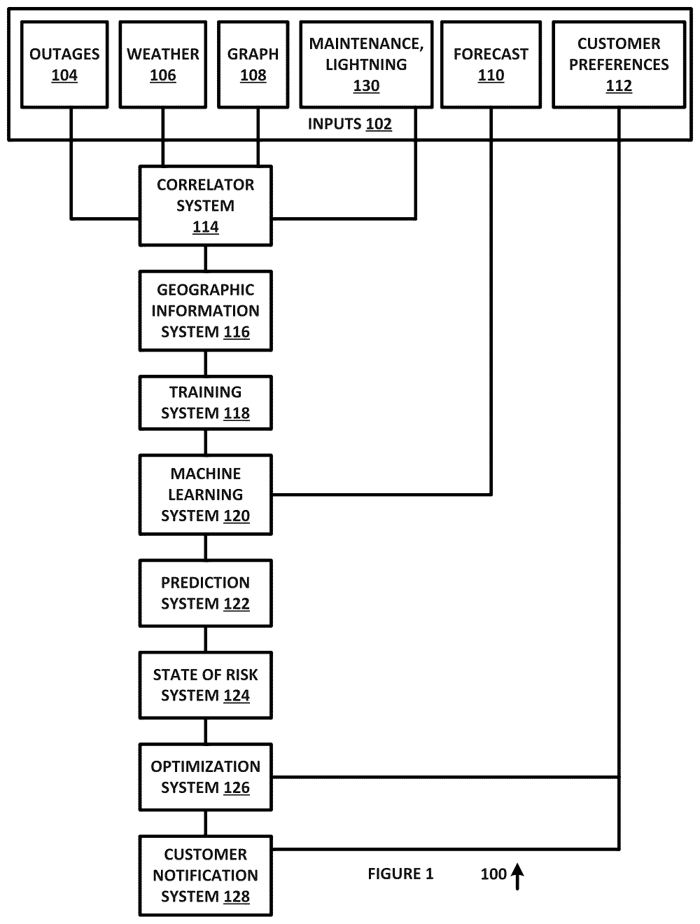

FIG. 1 is a diagram of a system 100 for customer notification as a function of outage SoR prediction, in accordance with an example embodiment of the present disclosure. System 100 includes input system 102, outages system 104, weather system 106, graph system 108, forecast system 110, customer preferences 112, correlator system 114, geographic information system 116, training system 118, machine learning system 120, prediction system 122, SoR system 124, optimization system 126, customer notification system 128 and maintenance, lightning and other data system 130 and can be implemented in hardware or a suitable combination of hardware and software.

Input system 102 can be implemented as one or more algorithms that are stored in a data memory and loaded into a working memory of a processor to cause the processor to coordinate data inputs to system 100. In one example embodiment, the data inputs can be obtained from several different data sources, some of which are available continuously from monitoring equipment, some of which are generated on demand, some of which are generated periodically and other suitable data sources. Input system 102 is configured to obtain data updates in response to the specific requirements of each data source, as further discussed and disclosed herein.

Outages system 104 can be implemented as one or more algorithms that are stored in a data memory and loaded into a working memory of a processor to cause the processor to generate outages data for planned, unplanned, historical or other outages. In one example embodiment, outages data can be obtained on demand or in real time from a third party, planned outages data can be provided in advance of an outage at a predetermined time, and other suitable processes and procedures for obtaining outages data can be utilized, as further discussed, and disclosed herein.

Weather system 106 can be implemented as one or more algorithms that are stored in a data memory and loaded into a working memory of a processor to cause the processor to read data and to generate weather data for current, historical or other suitable weather. In one example embodiment, weather data can be obtained on demand, in real time from a third party, can be provided in periodically and other suitable processes and procedures for obtaining weather data can be utilized, as further discussed, and disclosed herein.

Graph system 108 can be implemented as one or more algorithms that are stored in a data memory and loaded into a working memory of a processor to cause the processor to read data and to generate graphical data for use in analyzing outage predictions, as further discussed, and disclosed herein. In one example embodiment, graph system 108 can be used to define zones around distribution feeders and other equipment, to identify foliage, mountains and other geographic features, and to perform other suitable functions.

Forecast system 110 can be implemented as one or more algorithms that are stored in a data memory and loaded into a working memory of a processor to cause the processor to read data and to transform the data to generate load and generation data forecasts in response to planned loads and generation capacity, unplanned loads and generation, historical loads and generations or other suitable forecasts. In one example embodiment, outages data can be obtained on demand or in real time from a third party, planned outages data can be provided in advance of an outage at a predetermined time, and other suitable processes and procedures for obtaining outages data can be utilized, as further discussed, and disclosed herein.

Customer preferences 112 can be implemented as one or more algorithms that are stored in a data memory and loaded into a working memory of a processor to cause the processor to obtain and generate customer preference data. In one example embodiment, customer preferences can have a default setting for each customer that can be modified in response to queries to or inputs from each customer, customer preferences can be modified or overridden in response to emergency conditions, and other suitable customer preference data can be processed, as further discussed, and disclosed herein.

Correlator system 114 can be implemented as one or more algorithms that are stored in a data memory and loaded into a working memory of a processor to cause the processor to receive and correlate outage data, weather data, graph data and other suitable data. In one example embodiment, data from different data sets that does not align as to time or location can be transformed to correlate with each other, queries can be generated to obtain correlated data or other suitable processes and procedures can be used, as further discussed, and disclosed herein.

Geographic information system 116 can be implemented as one or more algorithms that are stored in a data memory and loaded into a working memory of a processor to cause the processor to receive data from correlator system 114 and to obtain and generate geographic information, as further discussed, and disclosed herein. In one example embodiment, buffer size constraints for hardware and software system components can be used to transform the data from correlator system 114 into geographic information, such as a predetermined number of buffers for an input data file as a function of file size or other suitable functions as discussed and disclosed herein.

Training system 118 can be implemented as one or more algorithms that are stored in a data memory and loaded into a working memory of a processor to cause the processor to receive data from geographic information system 116 and to transform the data by creating data sets for machine learning training. In one example embodiment, the training data sets can be generated as a function of processor limitations, such as to reduce the size of data sets or for other suitable purposes, as further discussed and disclosed herein.

Machine learning system 120 can be implemented as one or more algorithms that are stored in a data memory and loaded into a working memory of a processor to cause the processor to receive training system data and forecast data and to transform the training system data and forecast data to generate SoR data, such as using remote sensing and weather forecast or other suitable data, as further discussed and disclosed herein.

Prediction system 122 can be implemented as one or more algorithms that are stored in a data memory and loaded into a working memory of a processor to cause the processor to receive data from machine learning system 120 and to transform the data to generate outage prediction data, as further discussed and disclosed herein.

SoR system 124 can be implemented as one or more algorithms that are stored in a data memory and loaded into a working memory of a processor to cause the processor to receive outage prediction data and to transform the data to generate SoR data, as further discussed and disclosed herein.

Optimization system 126 can be implemented as one or more algorithms that are stored in a data memory and loaded into a working memory of a processor to cause the processor to receive SoR data and customer preference data and to transform the data to generate optimization data, as further discussed and disclosed herein.

Customer notification system 128 can be implemented as one or more algorithms that are stored in a data memory and loaded into a working memory of a processor to cause the processor to receive optimization data and customer preferences data and to transform the data to generate customer notifications, as further discussed and disclosed herein. Customer notification system 28 can also or alternatively receive data from an provide data to customer preferences system 112, such as to provide targeted feedback regarding customer responses to notifications in order to identify customers with heightened sensitivity to notification data, customers with outage data that can augment outage data in outages system 104 and for other suitable purposes.

Maintenance, lightning and other data system 130 can be implemented as one or more algorithms that are stored in a data memory and loaded into a working memory of a processor to cause the processor to receive maintenance schedule data (e.g. planned tree trimming), lightning strike data or other suitable data that is available for use in predicting outages and to provide the data to correlator system 114. Maintenance data can be transformed or modified in response to customer notification data, such as to schedule maintenance for customers that have responded to outage data and requested assistance. As discussed herein, configuring data inputs for compatibility with other data sets and other suitable processes can also be performed.

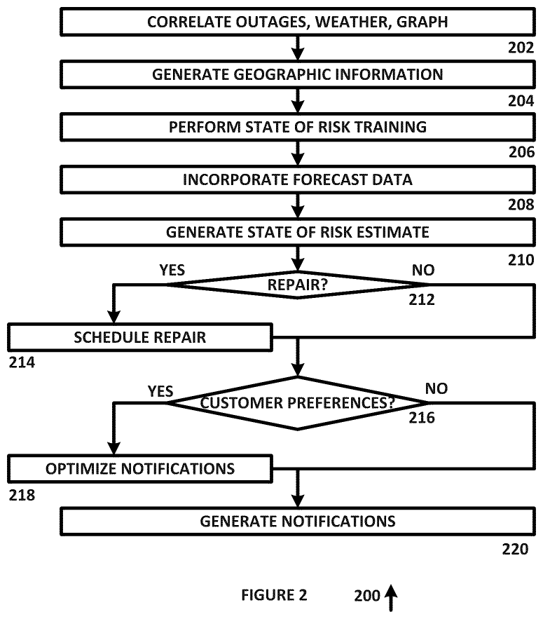

FIG. 2 is a diagram of an algorithm 200 for customer notification as a function of outage SoR prediction, in accordance with an example embodiment of the present disclosure. Algorithm 200 can be implemented in hardware or a suitable combination of hardware and software.

Algorithm 200 begins at 202, where uncorrelated outages data, weather data and graph data are correlated. In one example embodiment, the outages data, weather data and graph data can be correlated using geographic coordinate data that has been modified by finding a best fit, so as to result in matching coordinate data or in other suitable manners, as discussed and disclosed herein. The algorithm then proceeds to 204.

At 204, geographic information is generated. In one example embodiment, the geographic information can be generated as a function of correlated outages data, weather data and graph data, or other suitable processes and procedures can be implemented as discussed and described herein. The algorithm then proceeds to 206.

At 206, SoR training is performed. In one example embodiment, the SoR training can be performed using machine learning, or other suitable processes and procedures can be implemented as discussed and described herein. The algorithm then proceeds to 208.

At 208, forecast data is received at a machine learning system and is processed. In one example embodiment, the forecast data can be generated in response to updated weather data, load data, generation data, or other suitable processes and procedures can be implemented as discussed and described herein. The algorithm then proceeds to 210.

At 210, SoR estimate data is generated. In one example embodiment, the SoR estimate can be generated as a function of the forecast data as applied to the machine learning processes, or other suitable processes and procedures can be implemented as discussed and described herein. The algorithm then proceeds to 212.

At 212, it is determined whether a repair is needed. In one example embodiment, repair information can be received from customers, generation equipment operators, transmission equipment operators, distribution equipment operators, or other suitable processes and procedures can be implemented as discussed and described herein. If it is determined that repairs are needed, the algorithm proceeds to 214, otherwise the algorithm proceeds to 216

At 214, a repair and associated outage procedures are scheduled. In one example embodiment, the repair step can require an immediate equipment outage, a future equipment outage, customer load reductions, or other suitable processes and procedures can be implemented as discussed and described herein. The algorithm then proceeds to 216.

At 216, it is determined whether there are customer notification preferences. If it is determined that there are customer preferences, the algorithm proceeds to 218. Otherwise, the algorithm proceeds to 220.

At 218, notifications are optimized. In one example embodiment, the notifications can be optimized for specific customers, types of outages, type of weather, or other suitable processes and procedures can be implemented as discussed and described herein. The algorithm then proceeds to 220.

At 220, notifications are generated, as discussed, and described herein.

In operation, algorithm 200 can generate customer notifications as a function of outage SoR prediction. While algorithm 200 is shown as a flow chart, a person of skill in the art will recognize that it can also or alternatively be implemented as a state diagram, a ladder diagram, using object-oriented programming or in other suitable manners.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general-purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general-purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for customer notification based on outage state of risk prediction, comprising:
a correlator system operating on a processor and configured to receive uncorrelated outage data, weather data and graph data and to generate geographically correlated outage data, weather data and graph data;
a machine learning system operating on a processor and configured to receive geographically correlated outage data, weather data and graph data and forecast data and to generate prediction data;
a state of risk system operating on a processor and configured to receive the prediction data and to generate state of risk data; and
a customer notification system operating on a processor and configured to receive the state of risk data and to generate customer notifications as a function of the state of risk.

2. The system of claim 1 wherein the machine learning system further comprises a machine learning algorithm operating on the processor that iteratively trains a data model using the correlated outage data, weather data and graph data to modify an outage duration prediction.

3. The system of claim 2 wherein the machine learning algorithm utilizes continuous integration and continuous delivery to process new data for the outage data, weather data and graph data.

4. The system of claim 1 wherein the correlator system further comprises a machine learning algorithm operating on the processor that iteratively trains a data model using different combinations of feeder lines in the geographic data.

5. The system of claim 1 wherein the state of risk data comprises map data having a plurality of geographic zones, wherein each zone has an associated risk that can be different from an associated risk of other zones.

6. The system of claim 1 wherein the correlator system receives the uncorrelated outage data, weather data and graph data and generates the geographically correlated outage data, weather data and graph data by adjusting coordinates of the uncorrelated outage data, weather data and graph data to match a predetermined set of coordinates having a closest fit.

7. The system of claim 1 wherein the customer notification system is configured to receive customer response data and to modify the outage data in response to the customer response data.

8. The system of claim 1 further comprising a maintenance scheduling system configured to receive the state of risk data and to generate maintenance scheduling data in response to the state of risk data.

9. The system of claim 1 further comprising a maintenance scheduling system configured to receive the state of risk data and customer notification data and to generate maintenance scheduling data in response to the state of risk data and the customer notification data.

10. A method for customer notification based on outage state of risk prediction, comprising:
receiving uncorrelated outage data, weather data and graph data at a correlator system operating on a processor;
generating geographically correlated outage data, weather data and graph data using the correlator system;
receiving the geographically correlated outage data, weather data and graph data with forecast data at a machine learning system operating on the processor;
generating prediction data using the machine learning system;
receiving the prediction data at a state of risk system operating on the processor and generating state of risk data; and
receiving the state of risk data at a customer notification system operating on the processor and generating customer notifications as a function of the state of risk.

11. The method of claim 10 wherein a machine learning algorithm operating on the processor iteratively trains a data model using the correlated outage data, weather data and graph data to modify an outage duration prediction.

12. The method of claim 11 wherein the machine learning algorithm utilizes continuous integration and continuous delivery to process new data for the outage data, weather data and graph data.

13. The method of claim 10 wherein the correlator system further comprises a machine learning algorithm operating on the processor that iteratively trains a data model using different combinations of feeder lines in the geographic data.

14. The method of claim 10 wherein the state of risk data comprises map data having a plurality of geographic zones, wherein each zone has an associated risk that can be different from an associated risk of other zones.

15. The method of claim 10 wherein the correlator system receives the uncorrelated outage data, weather data and graph data and generates the geographically correlated outage data, weather data and graph data by adjusting coordinates of the uncorrelated outage data, weather data and graph data to match a predetermined set of coordinates having a closest fit.

16. The method of claim 10 wherein the customer notification system is configured to receive customer response data and to modify the outage data in response to the customer response data.

17. The method of claim 10 further comprising a maintenance scheduling system configured to receive the state of risk data and to generate maintenance scheduling data in response to the state of risk data.

18. The method of claim 10 further comprising a maintenance scheduling system configured to receive the state of risk data and customer notification data to generate maintenance scheduling data in response to the state of risk data and the customer notification data.
